(19) United States
(12) Patent Application Publication
(10) Pub. No.: US 2026/0243536 A1
(43) Pub. Date: Aug. 20, 2026

(54) Archery Bow Stand

(71) Applicants: Jacob Bowden, Tucson, AZ (US); Richard Beaman, Oracle, AZ (US)

(72) Inventors: Jacob Bowden, Tucson, AZ (US); Richard Beaman, Oracle, AZ (US)

(21) Appl. No.: 19/054,958

(22) Filed: Feb. 17, 2025

(51) Int. Cl. F41B 5/14; F16M 13/00

(52) U.S. Cl. CPC F41B 5/1453; F16M 13/005

(57) ABSTRACT

In some embodiments, an archery bow stand comprises a pivot mechanism, a post portion and a foot portion. The pivot mechanism is mechanically fixed to an archery bow frame. The post portion is connected to the pivot mechanism on one side and is movable relative to the pivot mechanism. The post portion is connected to the foot portion on the end opposite the pivot mechanism. The foot portion comprises the contact surface of the bow stand with the supporting surface.

### CROSS-REFERENCE TO RELATED APPLICATIONS

This application claims the benefit of U.S. Provisional Application No. 63/555,041 filed on Feb. 18, 2024 by the present inventors, the disclosure of which is hereby incorporated by reference in its entirety.

### BACKGROUND OF THE INVENTION

This invention relates generally to the field of archery, and more particularly to archery bow stands that support a bow on the ground or other surface.

When participating in the sports of target archery and archery hunting, there are times when the archer's bow needs to be set down, either to retrieve arrows from the target, or simply when both hands are needed for another purpose. When such an event occurs, the bow is often set on the ground to perform the activity. When a bow is set onto the ground, the long axis of the bow is set parallel to the supporting surface which has the potential of damaging bow hardware or attached accessories including but not limited to a bow sight, arrow rest, arrow quiver, arrows, cams, limbs, strings, and cables. The need to support an archery bow and attached accessories has been previously identified and has attempted to be addressed by the prior art.

Bow stands that represent the current state of the art attempt to address this need by supporting the bow in an upright position, where the long axis of the bow is perpendicular to the surface that it is set upon. Upright bow stands are typically used in target archery and for archery hunting from a stationary position (such as a ground blind), however upright bow stands have drawbacks that limit their broad use.

Most upright bow stands are temporarily affixed to the bottom limb(s) of the bow, and require the bow to rest forward on a long stabilizer or rest rearward on the bottom cam of the bow. The bottom cam which channels the bow string around its exterior can impact the ground with these bow stands which can either damage the cam (causing burs that could damage or ultimately sever the bow string) or damage the bow string directly. Upright bow stands position the bow with a relatively high center of gravity location above the ground, resulting in the need for these bow stands to have a large lateral footprint to increase stability. This typically increases the size and weight of the bow stand, many of which require removal from the bow prior to shooting. There are other upright bow stands that attach to the lower limb pocket or forward stabilizer mount location which are not required to be removed prior to shooting, but these bow stands still do not address the archery bow instability in an upright orientation, especially on non-horizontal surfaces or uneven terrain. Damage to bow hardware and attached accessories have been incurred by use of these upright bow stands as they are more prone to tip over with the higher center of gravity as compared to a bow orientation closer to parallel with the supporting surface.

In archery hunting applications where an archery bow must be carried by hand while hiking or in pursuit of game, upright bow stands with their large lateral extent can be difficult to carry in the field as they have a tendency to snag brush or interfere the archer's legs while hiking, and as such, are frequently removed from the bow during such periods. In archery hunting applications where archers are in close pursuit of game where maintaining a low profile is essential, currently available upright bow stands prevent the archer from attaining a profile less than approximately three feet from the ground based on the size of most modern hunting bows and because of this, limits their use in these types of hunting situations. Based on the limited effective range of archery equipment, many archers will crawl with their bows in a horizontal orientation to maintain the lowest profile possible to close the distance on their quarry. This cannot be achieved with upright bow stands while still maintaining distance of critical bow hardware and attached accessories (including the bow sight) from the ground.

Therefore, a need exists for novel archery bow stand designs that overcome one or more disadvantages of the prior art.

### SUMMARY OF THE INVENTION

In accordance with one embodiment, a bow stand comprises a body portion and a pivot mechanism that enables the bow stand to be mechanically fixed to the bow. In some embodiments, the body portion is movable with respect to the pivot mechanism. In some embodiments, the pivot mechanism has multiple pivot lock positions enabling the archery bow stand to be locked into deployed and stowed orientations. In some embodiments, the deployed orientation positions the body portion orthogonal to the archery bow frame at the attachment point. In some embodiments, the stowed orientation positions the body portion parallel to the archery bow frame at the attachment point. In some embodiments, the stowed orientation enables the archery bow to be attached or hung from other objects. In some embodiments, the body portion is further comprised by a post portion and foot portion. In some embodiments, the foot portion is separable from the post portion. In some embodiments, one or more weights may be connected between the post portion and foot portion to aid in bow balance. In some embodiments, the body portion is further comprised of an extendable post portion. In some embodiments, the body portion is further comprised of multiple independent legs providing multiple contact points with the supporting surface. In some embodiments, the body portion is separable from a bow frame adapter.

### BRIEF DESCRIPTION OF DRAWINGS

Some embodiments of the present invention are illustrated as an example and are not limited by the figures of the accompanying drawings.

FIG. 1 depicts a view of one embodiment of an archery bow stand.

FIG. 2 depicts a view of a one embodiment of an archery bow stand with the body portion further comprising a post and foot portion.

FIG. 3 depicts an exploded view of one embodiment of an archery bow stand.

FIG. 4 depicts a view of one embodiment of an archery bow stand mounted to an archery bow frame in one orientation.

FIG. 5 depicts a view of one embodiment of an archery bow stand mounted to an archery bow frame in an alternate orientation.

FIG. 6 depicts a view of one embodiment of an archery bow stand mounted to an archery bow relative to a supporting surface.

FIG. 7 depicts a view of one embodiment of an archery bow stand mounted to an archery bow in an upright orientation.

FIG. 8 depicts a view of one embodiment of an archery bow stand with an extendable post portion.

FIG. 9A depicts a view of one embodiment of an archery bow stand with the body portion further comprising two legs.

FIG. 9B depicts a partially exploded view of one embodiment of an archery bow stand with the body portion further comprising two legs.

FIG. 10A depicts a view of one embodiment of an archery bow stand with a body portion connected to a bow frame adapter.

FIG. 10B depicts a view of one embodiment of an archery bow stand with a body portion disconnected from a bow frame adapter.

FIG. 10C depicts an exploded view of one embodiment of an archery bow stand with a body portion removed from a bow frame adapter.

### DETAILED DESCRIPTION OF THE INVENTION

Accordingly, several advantages of one or more aspects are as follows: to provide a bow stand that enables the bow to be set down with a very low center of gravity relative to the ground preventing the bow from falling over and damaging hardware or attached accessories, that provides stable support for the archery bow on horizontal, non-horizontal or uneven terrain providing ground surface clearance to the bow sight, arrow rest, arrow quiver, arrows, bow string and cables, limbs and cams, that enables an archery hunter to maintain a low profile while pursuing game (including crawling with the bow) while still maintaining distance between the ground and the critical bow hardware and attached accessories, that does not require the bow stand to be removed to shoot or stow the bow in a case, that provides a feature to incorporate weights to aid in bow balance when at full draw, that provides an extendable body portion to be able to adjust the displacement distance from the supporting surface, that provides multiple legs to increase stability with multiple supporting surface contact points, and that can be quickly disconnected and removed from the bow. Other advantages of one or more aspects will be apparent from a consideration of the drawings and ensuing description.

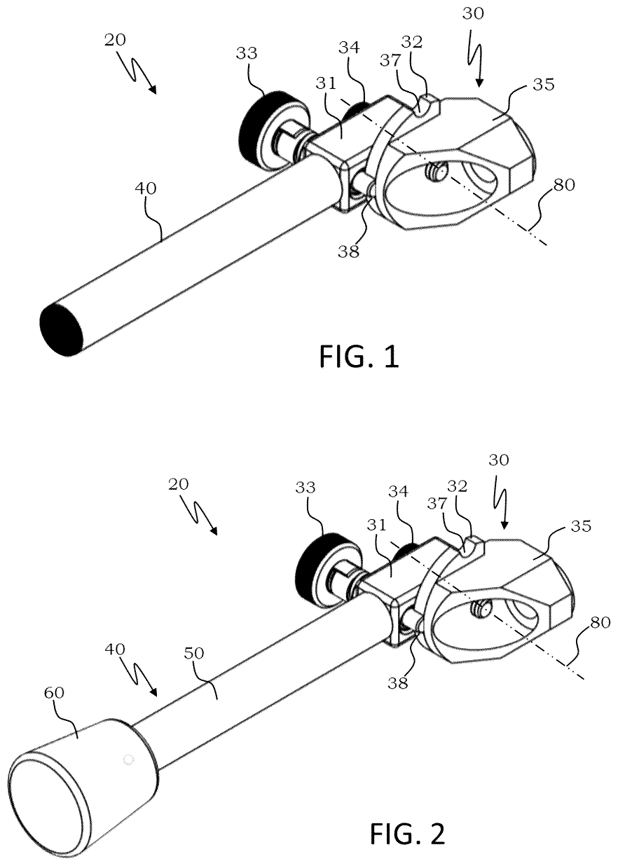

FIG. 1 depicts a view of one embodiment of an archery bow stand 20. In some embodiments, an archery bow stand 20 comprises a body portion 40 and a pivot mechanism 30 that are arranged to support an archery bow.

In some embodiments, the pivot mechanism 30 is further comprised of a pivot mechanism body 35, a pivot lock plate 32, a pivot axle 34, a pivot lock 33, and a pivot mechanism to body interface adapter 31. In some embodiments, the pivot mechanism body 35 provides the interface for attachment to an archery bow while also proving the interface for attachment of the pivot lock plate 32. In some embodiments, the pivot lock plate 32 has more than one pivot lock positions, represented by a first pivot lock position 37 and a second pivot lock position 38 in this view. In some embodiments, the pivot mechanism to body interface adapter 31 is attached to the body portion 40 and is attached to the pivot mechanism body 35 by way of a pivot axle 34. In some embodiments, the pivot mechanism to body interface adapter 31 also includes the pivot lock 33 that protrudes through the pivot mechanism to body interface adapter 31 and engages with either the first pivot lock position 37 or the second pivot lock position 38. In some embodiments, the body portion 40, joined with the pivot mechanism to body interface adapter 31, may pivot about the pivot axis 80 when the pivot lock 33 is disengaged from the pivot lock plate 32. In some embodiments, when the pivot lock 33 is engaged within either pivot lock position 37, 38, the body portion 40, when attached to the pivot mechanism to body interface adapter 31, will be prevented from pivoting about the pivot axis 80.

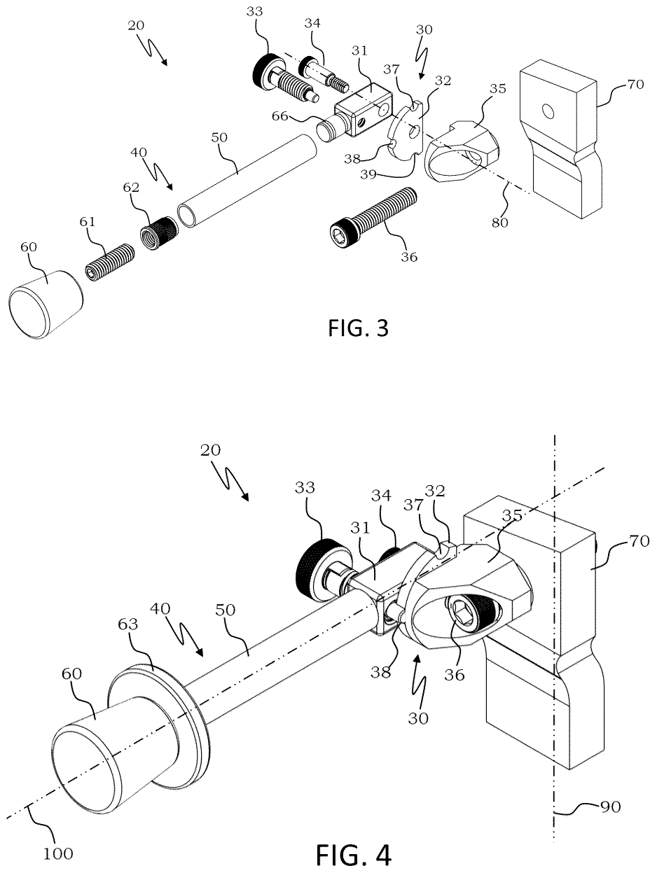

FIG. 2 depicts a view of one embodiment of an archery bow stand 20 wherein the body portion 40 is further comprised of a post portion 50 and a foot portion 60. In some embodiments, the post portion 50 is attached to the pivot mechanism to body interface adapter 31 on one end and is attached to the foot portion 60 on the opposite end. In some embodiments, the foot portion 60 is removable from the post portion 50.

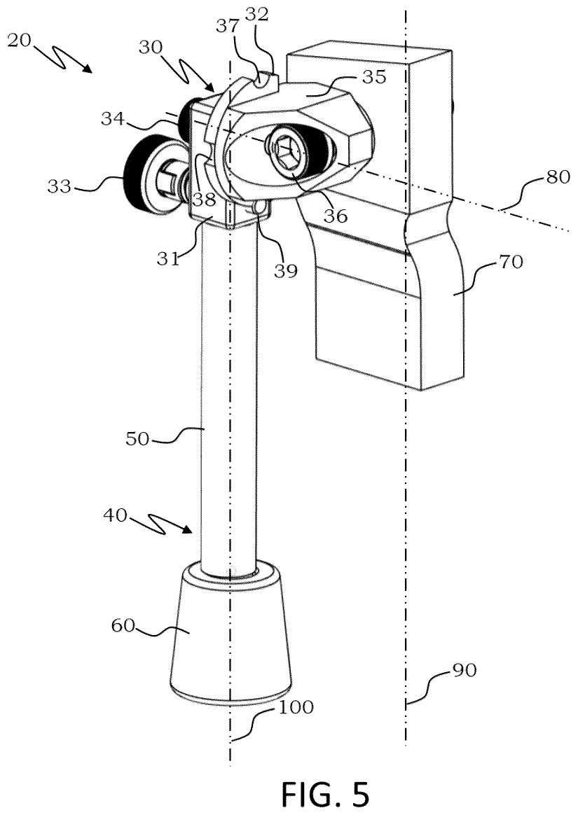

FIG. 3 depicts an exploded view of one embodiment of an archery bow stand 20. In some embodiments, the post portion 50 further comprises a threaded insert 62 to enable connection to the foot portion 60 also including a threaded interface. In some embodiments, a foot attachment screw 61 is used to attach the foot portion 60 to the post portion 50 by way of the threaded insert 62 that is fixed within the post portion 50. In some embodiments, the post portion 50 is attached to the pivot mechanism to body interface adapter 31 by way of a post adapter feature 66. In some embodiments, the pivot lock plate 32 has more than one pivot lock position (the first pivot lock position 37, the second pivot lock position 38, and a third pivot lock position 39 in this view). In some embodiments, a bow frame attachment screw 36 is used to attach the pivot mechanism body to an archery bow frame 70. In some embodiments, the pivot axle 34 includes a collar portion that prevents complete passage through the pivot mechanism to body interface adapter 31. In some embodiments, a smooth portion of the pivot axle 34 interfaces with a smooth bore within the pivot mechanism to body interface adapter 31, the threaded portion of the pivot axle 34 attaches to a threaded portion of the pivot mechanism body 35, thereby enabling the body portion 40 to pivot about the pivot axis 80. In some embodiments, the pivot lock 33 is retained in the first, second, or third pivot lock position 37, 38, 39, by spring force requiring compression of the spring to remove the pivot lock 33 from its locked position.

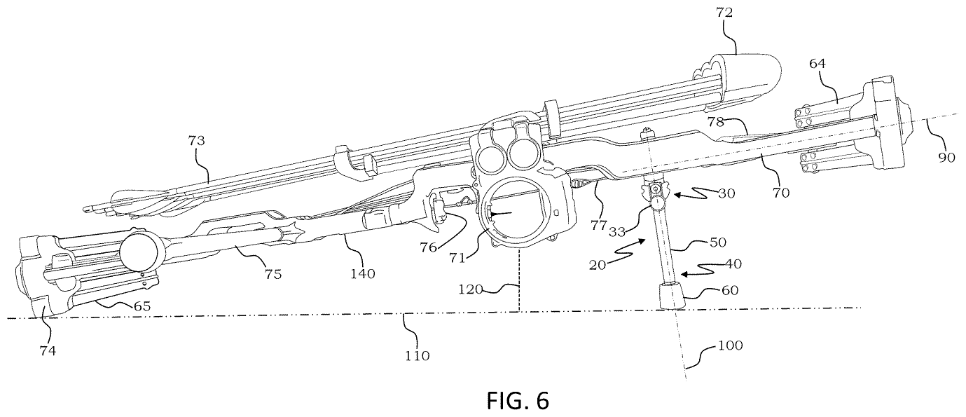

FIG. 4 depicts a view of one embodiment of an archery bow stand 20 wherein a weight 63 is mounted between the post portion 50 and foot portion 60. In some embodiments, the weight 63 has a threaded hole through the center and is threaded onto the foot attachment screw 61. In some embodiments, more than one weight 63 may be used to add additional mass to the foot end of the body portion 40.

In some embodiments, the second pivot lock position 38 provides a pivot lock engagement position for the pivot lock 33 which enables a body portion 40 orientation that is orthogonal to the mounting surface on the archery bow frame 70; orthogonality shown by the bow stand body axis 100 relative to the archery bow frame axis 90.

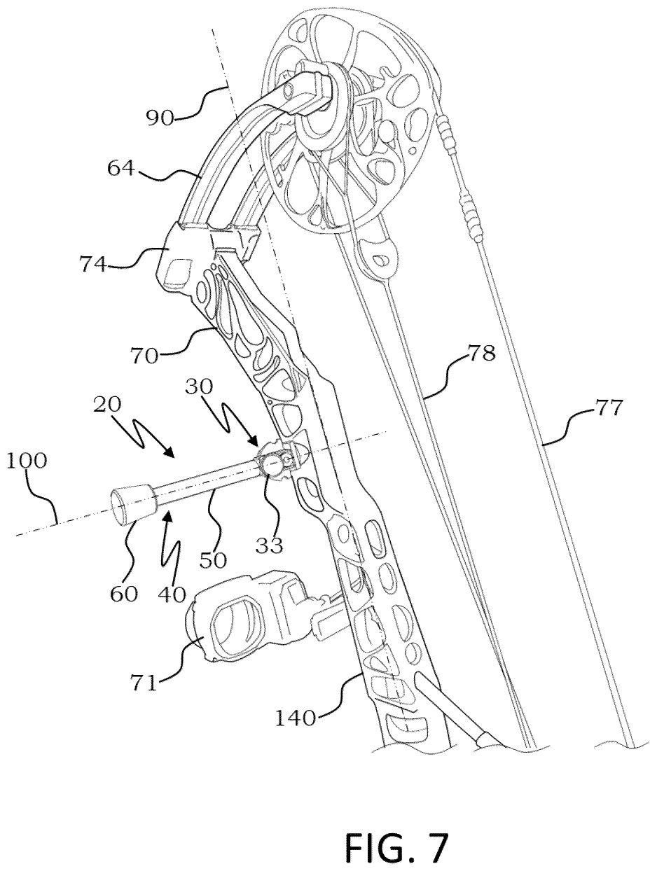

FIG. 5 depicts a view of one embodiment of an archery bow stand 20 with the pivot lock 33 engaged with the pivot lock plate 32 in the third pivot lock position 39. In some embodiments, at least one pivot lock position (the first pivot lock position 37 or third pivot lock position 39 in this case), provides the pivot lock engagement position for the pivot lock 33 which enables a body portion 40 orientation that is parallel to the mounting surface on the archery bow frame 70; parallelism shown by the bow stand body axis 100 relative to the archery bow frame axis 90, representing a stowed orientation of the archery bow stand 20.

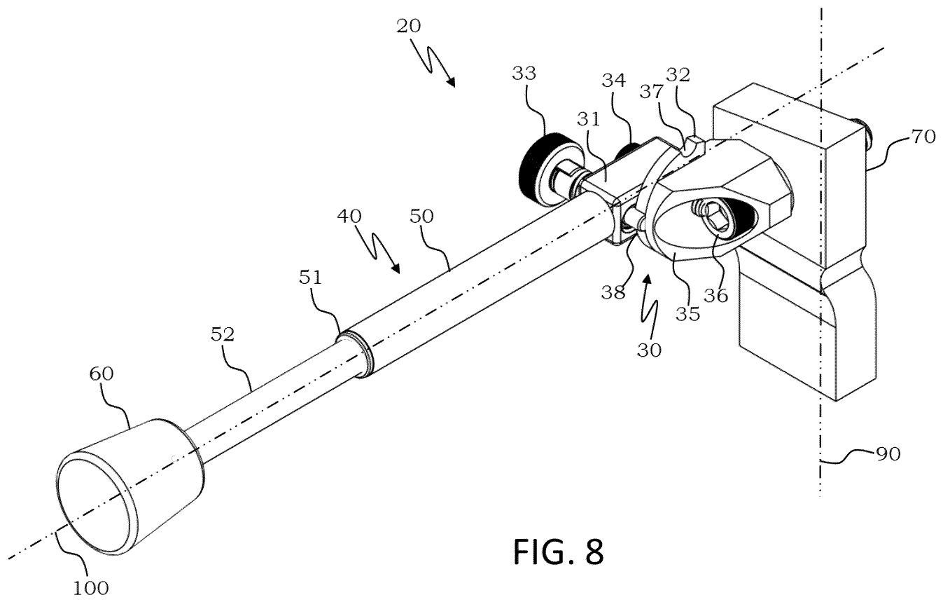

FIG. 6 depicts a view of one embodiment of an archery bow stand 20 mounted to an archery bow 140 with the archery bow stand 20 in contact with a supporting surface 110. In some embodiments, the archery bow stand 20 is oriented with the pivot lock 33 engaged within the deployed second pivot lock position 38 resulting in a bow stand body axis 100 that is orthogonal to the archery bow frame axis 90. In some embodiments, the aforementioned orientation provides bow sight 71 displacement distance 120 from the supporting surface 100. In some embodiments, the lower limb pocket 74, lower limb 65 and the foot portion 60 are in contact with the supporting surface 110. In some embodiments, the lower limb pocket 74, stabilizer 75 and the foot portion 60 are in contact with the supporting surface 110. In some embodiments, more than one archery bow stand 20 would be attached to the archery bow frame 70, to further elevate the archery bow 140 from the supporting surface 110. In some embodiments, the archery bow stand 20, prevents contact of the archery bow sight 71, the arrow rest 76 the bow string 77, the bow cables 78, the archery bow upper limb 64, arrow quiver 72, arrows 73, and stabilizer 75 from contacting the supporting surface 110.

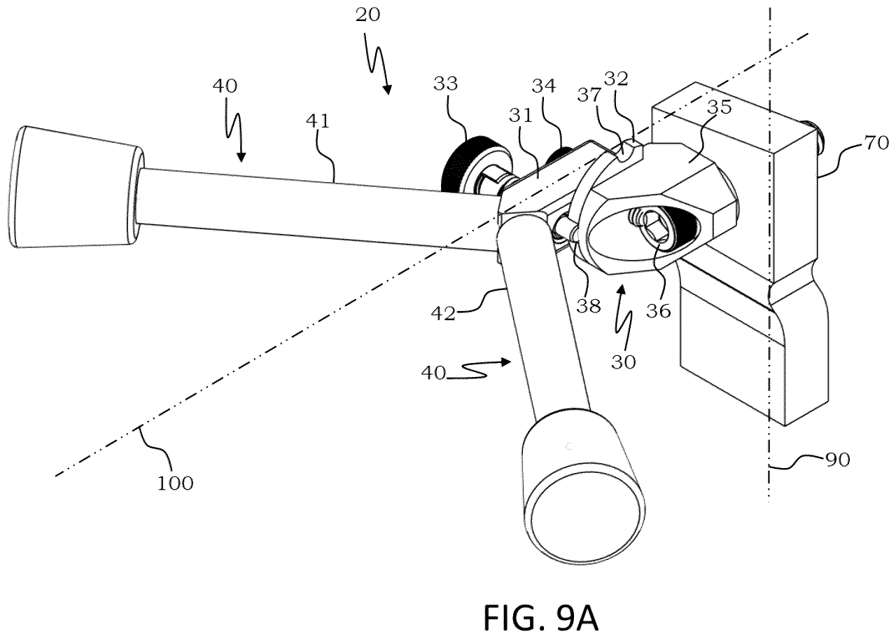

FIG. 7 depicts a view of one embodiment of an archery bow stand 20 mounted to an archery bow 140 positioned in an upright orientation. In some embodiments, the archery bow stand 20 is oriented with the pivot lock 33 engaged within the deployed second pivot lock position 38 resulting in a bow stand body axis 100 that is orthogonal to the archery bow frame axis 90. In some embodiments, the archery bow stand 20 would be mounted above the archery bow sight 71 to enable shooting with the bow stand 20 in a deployed orientation as shown in FIG. 7.

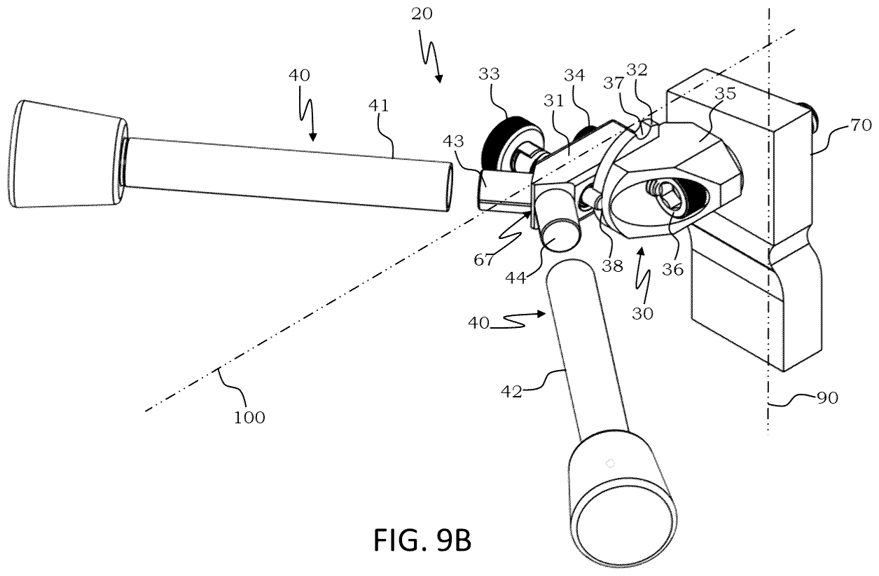

FIG. 8 depicts a view of one embodiment of an archery bow stand 20 mounted to an archery bow frame 70 where the body portion 40 is comprised by the post portion 50, a post extension interface 51, a post extension portion 52 and the foot portion 60. In some embodiments, the post extension interface 51 is a twist-lock mechanism which enables the post extension portion 52 to be slid into and out of the post portion 50 along the bow stand body axis 100. In some embodiments, the post extension portion 52 is rotated about the bow stand body axis 100 in one direction to unlock the post extension interface 51 enabling movement of the post extension portion 52, and is rotated in the opposite direction to lock the post extension interface 51 preventing movement of the post extension portion 52.

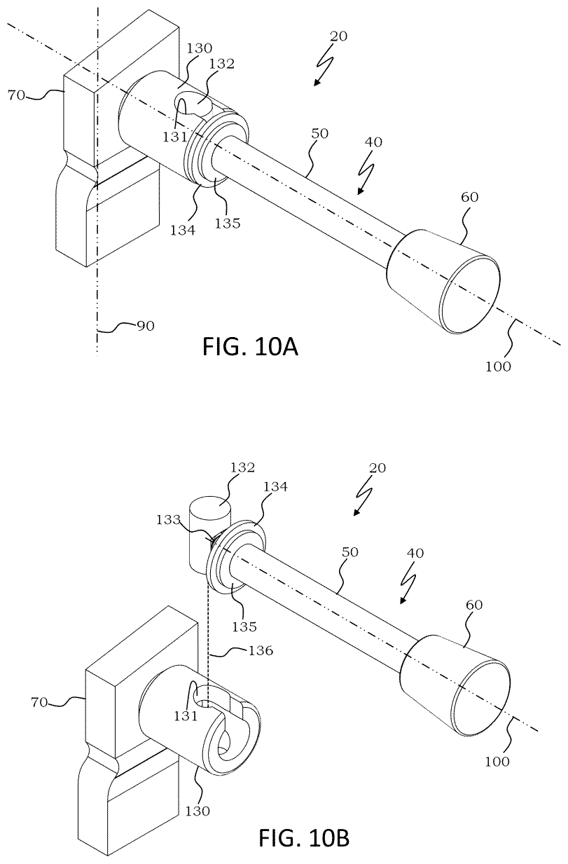

FIG. 9A depicts a view of one embodiment of an archery bow stand 20 mounted to an archery bow frame 70 where body portion 40 is further comprised of two legs, a body portion first leg 41, and a body portion second leg 42.

FIG. 9B depicts a partially exploded view of one embodiment of an archery bow stand 20 including the body portion first leg 41, body portion second leg 42, and a multi-post adapter feature 67. In some embodiments, the multi-post adapter feature 67 is further comprised of two protrusions, a first protrusion 43 and a second protrusion 44 that are fixed in position with respect to one another. In some embodiments, the body portion first leg 41 is connected to first protrusion 43, and the body portion second leg 42 is connected to the second protrusion 44 of the multi-post adapter feature 67. In some embodiments, the multi-post adapter feature 67 protrusions are adjustable in position relative to one another. In some embodiments, the archery bow stand 20 is oriented with the pivot lock 33 engaged within the deployed second pivot lock position 38 resulting in a bow stand body axis 100 that is orthogonal to the archery bow frame axis 90. In some embodiments, operation of the pivot mechanism 30 is unchanged with the inclusion of the multi-post adapter feature 67 as a part of the pivot mechanism to body interface adapter 31.

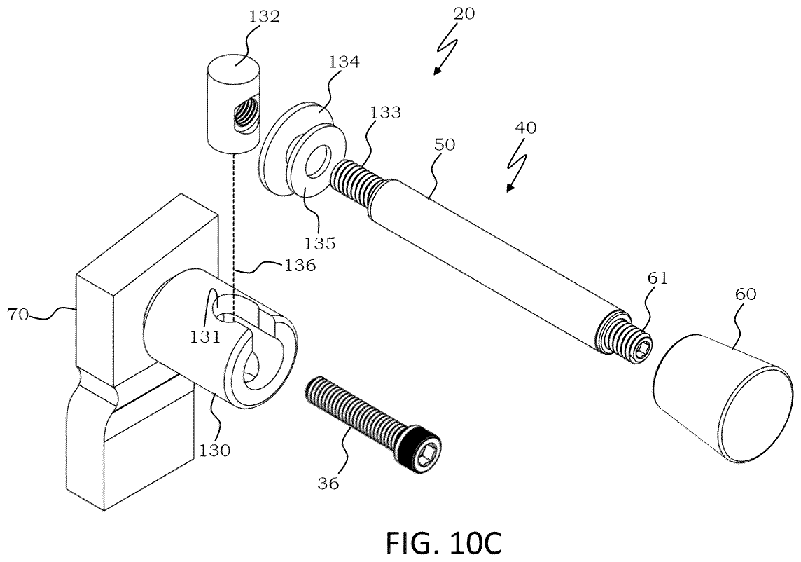

FIG. 10A depicts a view of one embodiment of an archery bow stand 20. In some embodiments, an archery bow stand 20 comprises a body portion 40 and a bow frame adapter 130 that are arranged to support an archery bow. In some embodiments, the bow frame adapter 130 provides the interface for attachment to an archery bow frame 70 while also proving the interface for attachment of for the body portion 40. In some embodiments, the bow frame adapter 130 is mechanically fixed to the archery bow frame 70. In some embodiments, the bow frame adapter 130 includes a quick disconnect socket 131 that is the appropriate size and shape to accept a quick disconnect coupling 132 in order to connect to the body portion 40. In some embodiments, a washer 134 is used to interface to the body portion 40 side of the bow frame adapter 130. In some embodiments, an anti-seize washer 135 is used to retain the post portion 50 while enabling easy body portion 40 removal. In some embodiments, when the body portion 40 is mounted to the bow frame adapter 130, and the bow frame adapter 130 is mounted to the archery bow frame 70, the body portion 40 orientation is orthogonal to the mounting surface on the archery bow frame 70; orthogonality shown by the bow stand body axis 100 relative to the archery bow frame axis 90.

FIG. 10B depicts a view of one embodiment of an archery bow stand 20 where the body portion 40 is separated from the bow frame adapter 130. In some embodiments, the quick disconnect coupling 132 is connected to the body portion 40 using a coupling screw 133. In some embodiments, the coupling screw 133 can thread into and out of the quick disconnect coupling 132 by rotating the body portion 40 about the bow stand body axis 100, depending on the direction of rotation this will loosen or tighten the joint between the body portion 40 (including washer 134 and anti-seize washer 135) and the bow frame adapter 130 when the quick disconnect coupling 133 is engaged within the quick disconnect socket 131. In some embodiments, when the quick disconnect coupling 132 is loosened, the body portion 40 with the washer 134, anti-seize washer 135, coupling screw 133 and the quick disconnect coupling 132 itself, can be separated from the bow frame adapter 130 along the quick disconnect axis 136. In some embodiments, the body portion 40 with the washer 134, anti-seize washer 135, coupling screw 133 and the quick disconnect coupling 132 can be reattached with the bow frame adapter 130 by inserting the quick disconnect coupling 132 into the quick disconnect socket 131 along the quick disconnect axis 136; once inserted, the body portion 40 can be rotated in the opposite direction that was used to loosen the body portion 40 in order to tighten and firmly mount the body portion 40 to the bow frame adapter 130.

FIG. 10C depicts an exploded view of one embodiment of an archery bow stand 20 where the body portion 40 is separated from the bow frame adapter 130. In some embodiments, the bow frame adapter 130 is mounted to the archery bow frame 70 with the bow frame attachment screw 36 prior to engaging the quick disconnect coupling 132 with the quick disconnect socket 131. In some embodiments, the quick disconnect coupling 132 is cylindrical in shape with a threaded interior enabling connection to the post portion 50 using the coupling screw 133. In some embodiments, the coupling screw 133 is secured to the post portion 50 to prevent rotation between the coupling screw 133 and the post portion 50.

1. A bow stand arranged to support an archery bow, the archery bow consisting of a frame and the bow stand comprising:
a body portion and pivot mechanism, the body portion connected to the pivot mechanism on one end, the body portion movable with respect to the pivot mechanism;
the body portion comprising the contact surface on the end opposite the pivot mechanism;
the pivot mechanism mechanically fixed to the archery bow frame;
the bow stand body portion comprising a first longitudinal axis, and the archery bow frame comprising a second longitudinal axis;
the bow stand comprising a first orientation where the first longitudinal axis is orthogonal to the second longitudinal axis, and a second orientation where the first longitudinal axis is parallel to the second longitudinal axis;
the bow stand arranged to support an archery bow, with the contact surface in contact with the supporting surface.

2. The bow stand of claim 1, the body portion further comprising:
a post portion and foot portion, the post portion connected to the pivot mechanism on one end and the foot portion on the other end.

3. The bow stand of claim 1, comprising a body portion of adjustable length.

4. The bow stand of claim 1, the body portion further comprising two or more legs each providing an independent contact surface with the supporting surface.

5. The bow stand of claim 1, comprising an orientation where the first longitudinal axis is nonorthogonal and nonparallel to the second longitudinal axis.

6. The bow stand of claim 2, the foot portion comprising the contact surface.

7. The bow stand of claim 2, further comprising a weight connected between the post portion and foot portion.

8. A bow stand arranged to support an archery bow, the archery bow consisting of a frame and the bow stand comprising:
a body portion and bow frame adapter, the body portion connected to the bow frame adapter on one end;
the body portion comprising the contact surface on the end opposite the bow frame adapter;
the bow stand body portion comprising a first longitudinal axis, and the archery bow frame comprising a second longitudinal axis;
the bow stand comprising a first orientation where the first longitudinal axis is orthogonal to the second longitudinal access;
the bow stand arranged to support an archery bow, with the contact surface in contact with the supporting surface.

9. The bow stand of claim 8, the body portion separable from the bow frame adapter.

10. The bow stand of claim 8, the body portion further comprising:
a post portion and foot portion, the post portion connected to the bow frame adapter on one end and the foot portion on the other end.

11. The bow stand of claim 8, comprising a body portion of adjustable length.

12. The bow stand of claim 8, the body portion further comprising two or more legs each providing an independent contact surface with the supporting surface.

13. The bow stand of claim 8, comprising an orientation where the first longitudinal axis is nonorthogonal to the second longitudinal axis.

14. The bow stand of claim 10, the foot portion comprising the contact surface.

15. The bow stand of claim 10, further comprising a weight connected between the post portion and foot portion.
